(19) United States
(12) Patent Application Publication
(10) Pub. No.: US 2015/0164096 A1
(43) Pub. Date: Jun. 18, 2015

(54) METHOD FOR CONSERVING FOODSTUFFS INCLUDING FISH

(71) Applicants: Alain Olivieri, La Cadiere D'Azur (FR); Benoit Ronsin, Plogonnec (FR); Christine Nauleau, Douarnenez (FR)

(72) Inventors: Alain Olivieri, La Cadiere D'Azur (FR); Benoit Ronsin, Plogonnec (FR); Christine Nauleau, Douarnenez (FR)

(73) Assignee: ETABLISSEMENTS PAUL PAULET, Douarnenez (FR)

(21) Appl. No.: 14/403,456

(22) PCT Filed: May 23, 2013
(86) PCT No.: PCT/FR2013/051127

§ 371 Date: Nov. 24, 2014

(30) Foreign Application Priority Data
May 23, 2012 (FR) 1254729

(51) Int. Cl. A23B 4/20; A23L 1/325

(52) U.S. Cl. CPC A23B 4/20; A23L 1/325; A23V 2002/00

(57) ABSTRACT

The method of conserving foodstuffs enables foodstuffs including fish in the form of a slab to be conserved. The method includes the following preparation steps: preparing raw fish by adding a water-retaining agent; forming a slab; and sterilizing the foodstuffs.

The present invention relates to a method of conserving foodstuffs, in particular for long-duration conservation of foodstuffs comprising fish and in the form of a slab.

In the field of conserving fish, packages are already known that comprise fish in the form of a slab, such as a slab of tuna. In order to ensure conservation of duration that is sufficiently long, it is generally necessary to sterilize the foodstuffs contained in the package. Sterilization needs to be performed at a minimum temperature for eliminating microbes, and that has the effect of cooking the fish during this step.

When preparing slabs of fish, and most particularly slabs of whole fish, it is found that such sterilization tends to dry out the fish, so that the slab is perceived by the consumer as being tough. This problem arises particularly with fish such as tuna.

A particular object of the present invention is to provide a method of conserving foodstuffs that enables a slab of fish to be provided that is particularly tender at the time it is consumed.

To this end, the invention provides a method of conserving foodstuffs, the foodstuffs comprising fish and being in the form of a slab, the method comprising the following preparation steps:
preparing raw fish by adding a water-retaining agent;
forming a slab; and
sterilizing the foodstuffs.

It is thus proposed to form the slab of fish from a preparation in which a water-retaining agent has been added to the raw fish. This has the effect of making the fish particularly tender after it has been sterilized. The method is particularly advantageous when it is desired to conserve slabs of grilled tuna, since under such circumstances the sterilization step in addition to the grilling step runs the risk of making the slab particularly dry.

The term “water-retaining agent” is used to mean a substance that has the function of retaining water, in particular during sterilization, in order to ensure that the fish is tender at the time it is consumed. It can also be understood that this substance is different from adding salt, since salt cannot exert a sufficient water-retaining function without significantly spoiling taste.

The term “fish in the form of a slab” is used generally to mean fish in the form of a one-piece block of fish, as distinguished for example from fish flakes, or indeed minced fish. Such a slab of fish may also be referred to as a fish “steak”. It is in the form of a single piece of whole fish or else, as described below, in the form of a few pieces of whole fish that are agglomerated. Generally, the slab of fish is of predetermined shape and size that do not depend on the size of fish from which the slab is made. Thus, a slab of fish is generally different from a fillet of fish, which corresponds to a piece cut in the direction of the spinal column of the fish, and that is of a size that depends on the size of the fish from which it is taken. Furthermore, a slab of fish also generally differs from a steak proper of fish, which corresponds to a complete slice of fish and which likewise depends on the size of the fish.

It should be observed that the method described below is performed for long conservation of the foodstuffs, generally conservation with a duration lying in the range 12 months to 24 months. Furthermore, the method enables foodstuffs to be conserved at ambient temperature.

It can also be understood that the foodstuffs conserved using the method described below is made up in the great majority by fish, it being possible for additional ingredients to be added such as water, oil, pepper, salt, transglutaminase, and carrageenans. Preferably, the quantity by weight of fish in the recipe relative to the other ingredients is greater than 75%. The above-described slab is generally a slab that needs to be made soft even though it has been subjected to sterilization.

The above-described method may also include one or more of the following characteristics, taken singly or in combination.
The method includes a step of thawing the fish in order to obtain raw fish.
The water-retaining agent comprises carrageenans. This substance, which is also known as carrageenin, is a polisaccharide, being a molecule made up of a chain of sugars extracted from red seaweed. Carrageenans are presently given code E407 in the food additive classification. By using this water-retaining agent, the fish presents a texture that is similar to that of fresh fish, even though the fish has been subjected to sterilization. The water-retaining agent could alternatively comprise other water-retaining agents such as for example chemically modified starch of maize, or of tapioca, or native starch of rice.
The water-retaining agent is added by churning, and preferably by churning under a vacuum. This method consists in working the fish in a vacuum, while injecting liquid into it, in particular injecting the water-retaining agent. It is also possible to mix in other ingredients together with the water-retaining agent, such as water, oil, salt, pepper, etc.
The method includes a step of adding an enzyme, such as transglutaminase. This enzyme serves to bond fish proteins together and thus serves in particular to stick a plurality of fish pieces together during the forming step. It is thus possible to form slabs of fish by sticking together a few pieces of whole fish. An advantage of transglutaminase lies in the fact that it is considered as being a technological adjuvant and therefore does not need to be declared as an ingredient in the final product that is put on the market, which is advantageous in the food industry.
The enzyme is added using a mixer. It is thus possible to add an enzyme with a very uniform distribution at the surfaces of the fish pieces within a length of time shorter than 25 minutes (min), which cannot be done during the churning step, since that would give rise to problems of adhesion.
The slab-forming step comprises a step of molding a block of fish, and a subsequent step of portioning, also referred to as slicing, the block into a plurality of slabs. This portioning or slicing consists in cutting the block of fish that was molded during the molding step into slabs. Thus, making the slab of fish by the method described herein does not consist in a single step of cutting a whole fish piece, which would lead to slabs of fish being of varying sizes depending on the size of the fish, unless a very large quantity of waste is acceptable. A particular advantage of molding a block thus lies in the fact that, with such a block, it is possible subsequently to obtain a plurality of slabs of tuna that are constant in shape and weight. It can be understood that the molded block ds generally made up of a plurality of fish pieces that are stuck together, e.g. as a result of adding transglutaminase. Advantageously, when transglutaminase is added to the fish, the molding step follows on directly and quickly from adding the transglutaminase, so that the transglutaminase bonds together the proteins which would make molding more difficult if it took place later. In other words, the period of time between the step of adding transglutaminase and the step of molding is preferably shorter than 1 hour (h).
The forming step of the method includes a maturing step during which the molded block of fish is stored for a duration of longer than 12 h at a temperature of less than 6° C., and preferably less than 4° C., prior to being subjected to portioning.
The method includes a step of crusting a block of fish, during which the block of fish is exposed to a temperature lying in the range −25° C. to −15° C. for a duration longer than 20 min, preferably longer than 40 min. In this way, subsequent cutting of a block into slabs is made easier by the fact that the surface temperature of the block is close to −2° C., which avoids having problems of shearing the fish flesh.
The method includes a step of forming bars of rectangular section, these bars being made after the step of crusting the block of fish.
Preferably, the crusting step is followed by a portioning step.
The slab is substantially rectangular in shape and is of weight lying in the range 70 grams (g) to 250 g, and preferably in the range 100 g to 200 g. Thus, a slab of fish is of constant weight and shape at the end of the portioning or slicing step. The method includes a step of grilling before sterilizing. This grilling step comprises a step of braising preferably followed by a step of marking. The braising step consists in cooking (or precooking) only the periphery of the slab of fish, enabling the slab to be stiffened, while leaving its core raw. For example, the cooking (or precooking) of the slab takes place over about 25% of the total thickness of the slab, preferably over 10% of the total thickness of the slab, the remainder of the slab remaining raw. A particular advantage of this braising step, without cooking through to the core, lies in the fact that the fish proteins still remain ungelled at this stage, and therefore become gelled only during the sterilization step. Thus, because the fish remains raw in the core after the braising step, a fraction of the proteins will gel during the sterilizing step, thereby strengthening the internal cohesion of the slab. If the fish were to be cooked through to the core beforehand, then the heat during sterilization would no longer have the effect of generating strong bonds between proteins, but would act rather to disintegrate the proteins and cause the slab of tuna to crumble. The presently proposed braising step thus serves to prepare a slab that is particularly soft without spoiling either its shape or its texture. Furthermore, the marking step serves to give the surface of the slab the impression of being cooked on a barbecue, in particular by coloring the fish during very brief contact with a piece of metal heated to high temperature.
The slab-forming step is a step of assembling together whole fish pieces, with the number of pieces of fish preferably lying in the range one to five, advantageously in the range of two to three whole fish pieces. The presently described method presents the advantage of not forming a slab of fish that is constituted by entirely reconstituted fish, while still being capable of providing a slab that presents shape and weight that are constant. Thus, since the slab of fish is made up of a maximum of five pieces, and preferably of fewer than three pieces, the consumer has the sensation of eating whole fish, while still having a slab of fish that is of shape and weight that do not depend on the size of the fish from which it comes. This method that makes it possible to agglomerate a few pieces of fish, also presents the advantage of avoiding waste while performing the method. If a consumer looks closely, it is possible to distinguish a piece of whole fish because such a piece has all of its fibers in the same direction, thus distinguishing it from a piece of reconstituted fish, for example.
The fish may be tuna. The fish could equally well be salmon, mackerel, or white fish such as cod, halibut, JohnDory, bream, etc.
The method includes a step of transporting the slab in an individual cup adapted to receive the shape of the slab and adapted to be tipped into a package. The method includes a step of packaging and sealing the package under a vacuum or by injecting an inert gas, preferably after the step of grilling and before step of sterilizing the foodstuffs. Generally, the package is in the form of a sterilizable pouch.

The invention also provides foodstuffs packaging for long-duration conservation of the foodstuffs, the foodstuffs comprising fish and being in the form of a slab, the slab comprising one to five whole fish pieces. Preferably, the slab comprises two to three whole fish pieces. Generally, the slab comprises only two whole fish pieces.

It can be understood that a whole fish piece is a piece of fish flesh that has not been subjected to prior mechanical processing. In particular, a whole fish piece is not a piece of reconstituted fish flesh. It can also be understood that a whole fish piece can be recognized in particular because it presents all of its fibers in the same direction. It is thus possible to recognize the exact number of whole pieces that make up the above-described slab, merely by observing the number of portions of the slab that present fibers that are in directions that are different.

The invention can be better understood on reading the following description given purely by way of example and made with reference to the drawings, in which:

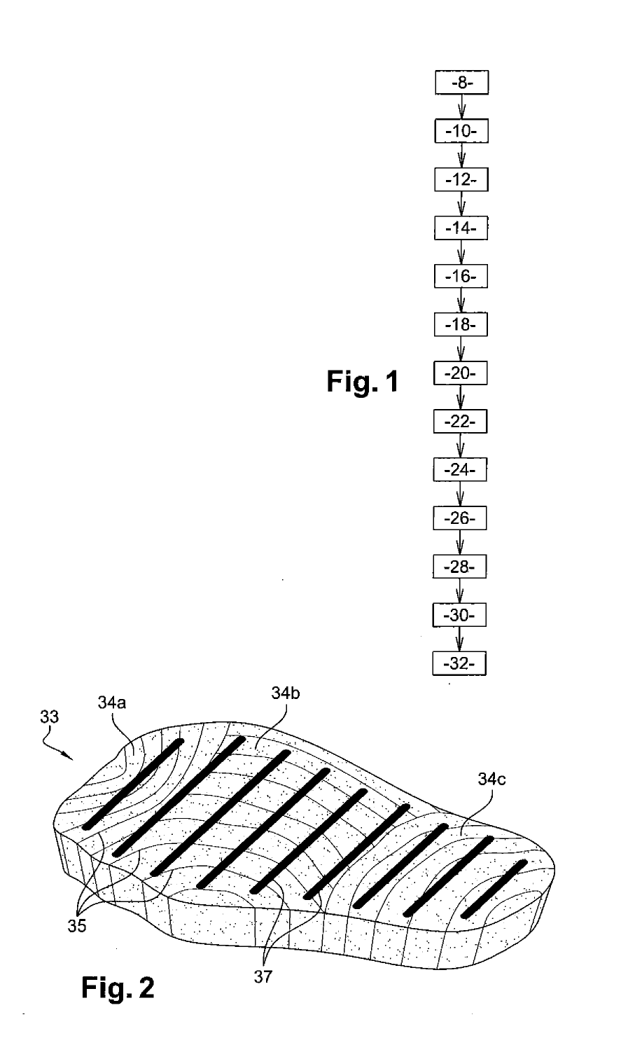

FIG. 1 is a flow chart showing a conservation method in an implementation; and

FIG. 2 is a diagrammatic view showing foodstuffs conserved using the method shown in FIG. 1, outside its packaging.

An example of a method of conserving foodstuffs as set out above is described below with reference to FIG. 1.

The method begins with a step 8 of thawing fish in order to obtain raw fish. In this example, the fish is tuna. This thawing step 8 is quite difficult to perform insofar as the raw fish needed for making slabs must be obtained at a speed that is fast enough to feed a production line, but without that leading to the flesh of the raw fish being heated too quickly, since that would spoil the quality of the slabs. Thus, for thawing, the frozen fish protected by polypropylene packaging is put into carts that are passed through a spray of water under pressure at a temperature lying in the range 9° C. to 15° C.

There follows a step 10 of filleting the raw fish. By way of example, this step 10 comprises a step of skinning, boning (removing the bones), and possibly a step of cutting up an entire fish. In an example, the mean weight of an initial entire fish may be 2.5 kilograms (kg) for skipjack tuna or 40 kg for yellowfin tuna.

The filleting step 10 is followed by a churning step 12. During this step 12, the fish is loaded into a container and then a vacuum pump is started. Once a certain degree of vacuum has been reached (e.g. −500 millibars (mbar)), brine is pumped into the container and very slow rotation of the container is started specifically for the purpose of working the fish. The brine is generally water associated with salt. During this step 12, other ingredients are also transferred into the container, in particular a water-retaining agent, specifically water-retaining hydrocolloides such as carrageenans and also pepper, such as a three-pepper mixture. Rotation then takes place for 1 hour, at a speed of 2.5 revolutions per minute. During a second period of the churning step 12, oil is transferred, such as rapeseed oil or sunflower oil. The rotation operation is continued for about 20 min.

The churning step 12 is followed by a step 14 of adding an enzyme that has properties of bonding pieces of fish flesh together by creating covalent bonds between certain amine groups. This enzyme is known as transglutaminase. This enzyme-adding step 14 lasts for 3 min to 5 min and is performed in a mixer at a speed of rotation and an angle of inclination that are defined by a program specially designed for this enzyme-adding step 14.

The step 14 of adding transglutaminase is quickly followed by a step 16 of molding the preparation. By way of example, the molding is performed in molds of silicone, of polypropylene, or of metal with a Teflon surface covering. It serves to prepare molded plates or blocks of thickness advantageously corresponding to the thickness of the finished product, i.e. to the thickness of a slab of tuna in the presently described example. In a non-limiting example, a molded block may present the following dimensions: length approximately 1 meter (m), width approximately 20 centimeters (cm), height approximately 6 cm.

The molding step 16 is followed by a maturing step 18 during which the transglutaminase can perform its bonding function between the fish proteins. By way of example, this maturing step 18 may last for 18 hours (h) during which a block is stored in a cold chamber at a temperature lying in the range 0° C. to 4° C. Alternatively, this step may be shorter in duration but not less than 12 h and at a temperature that does not exceed 6° C.

Thereafter, the method has a crusting step 19 for the purpose of hardening the outer surface of the molded block of fish. This step is performed by exposing the block to a temperature of −20° C. for about one hour. The crusting step 19 is for the purpose of obtaining a temperature of −2° C. at the surface of a block over a depth lying in the range 1.5 cm to 2.5 cm. Alternatively, the temperature could lie in the range −25° C. to −15° C. for a duration longer than 20 min, and preferably longer than 40 min.

The method then passes on to a step 20 of slicing or portioning a molded block so as to provide slabs in their final shape, i.e. a shape that is constant for each of the slabs, e.g. a rectangular shape. A block is dimensioned in such a manner as to make it possible to obtain a plurality of slabs while portioning.

In a preferred implementation, the molded block is cut longitudinally so as to make bars of rectangular section, and then these bars are inserted into vertical tubes in a cutting machine. The inserted bars move down under the effect of gravity into the cutting machine and a very fine blade cuts the blocks in order to obtain slabs. The fine blade combined with the fact that the blocks of fish present a surface temperature of −2° C. makes it possible to avoid phenomena of the blocks of fish shearing when they are sliced or portioned. By way of non-limiting example, a slab of tuna in an embodiment may have a length of 10 cm, a width of 6 cm, and a thickness of 2 cm. The slab may present net weight of close to 120 g after step 20, with this weight remaining more or less constant at the end of sterilization.

The step 20 is followed by a grilling step 22, 24. The grilling step comprises firstly a braising step 22, followed by a marking step 24. The braising step 22 is a step during which the periphery of the slab is precooked, while leaving the core of the slab raw. In an example, the periphery of the slab is cooked by natural convection without contact and without ventilation, using infrared heating. The heating temperature is about 700° C. and the surface temperature of the slab lies in the range 150° C. to 200° C. The purpose of this step 22 is not to cook the slab right through, to ensure that the fish proteins do not gel during this step, but only subsequently during the sterilization step. For example, the precooking of the slab takes place over about 25%, and preferably 10% of the entire thickness of the slab, the rest of the slab remaining raw.

The marking step 24 is a step for marking the slab to give the impression that it has been cooked on a barbecue. The marking is in the form of lines and is performed immediately after the braising step 22 so as to benefit from heating inertia in order to mark the product by making contact very briefly with a piece of metal heated to high temperature together with the slab. In this example, the contact time lies in the range 1 second (s) to 2 s, and the temperature is close to 450° C.

Thereafter, the method moves on to a step 26 of checking the weight of the slab, followed by a packaging step 28 and a sealing step 30. Upstream from the packaging step, the slabs of tuna are transported by means of polypropylene cups of shape specifically adapted to contain a slab in accordance with the present embodiment. The cups used for transporting the slabs of tuna are adapted to be tilted so as to cause the slabs of tuna to slide into respective pouches. Nevertheless, it is possible to envisage transporting the slabs directly in sachets. More precisely, the packaging step is performed by a pouch-filling machine, during which suction cups are used to take hold of a pouch, the pouch is then held between clamps, it is opened by means of a spout, and a slab is inserted therein by tilting the slab into a cone of shape adapted to the format of the pouch and of the slab. At the end of this packaging step, a small amount of sauce is optionally inserted using a volumetric metering device, e.g. for delivering about 15 g. By way of example, the sauce may be olive oil or tomato basil sauce.

The sealing step 30 is performed in a vacuum or by injecting an inert gas in order to prevent oxygen being in contact with the slab of fish. Sealing is followed by a sterilization step 32. During this step, various temperature pauses are implemented so as to avoid overcooking during the temperature rise and so as to terminate at a high temperature in order to minimize processing time. This type of sterilization is said to be “multistage”. The temperature rises quickly up to 115° C., and then more slowly and progressively up to 121° C. The total duration of the temperature rise is about 25 min. In addition to sterilization, this sterilization step serves to cook the fish. An effect of the “multistage” sterilization is to obtain a grilled and sterilized slab of fish that is particularly tender.

The method is then terminated and it is then possible to move on to a step of storing and transporting the packages for distribution and sale. The final product in its packaging has a net weight of about 125 g.

In one particular embodiment, the ingredients added during the above-described method can be summarized as follows
78% raw tuna fillet;
17.5% water;
3.5% rapeseed oil;
0.3% carrageenan;
0.1% three-pepper mixture; and
0.6% transglutaminase; with
1.3% salt.

The foodstuffs contained in the packaging at the end of the method of FIG. 1 is shown in FIG. 2. As can be seen in this figure, the slab 33 is made up of several pieces of whole fish 34a, 34b, 34c, specifically three pieces in this example. The three pieces 34a, 34b, 34c can be distinguished in particular by the orientations of their fibers 35, which are different for each of them. Transverse marks 37 associated with the marking step 24 are visible on the surface.

It should be observed that the invention is not limited to the implementations described above. For example, in a different implementation, it is possible to omit the step of making a block of fish, with slabs being made directly by molding. Under such circumstances, each slab comes from a mold of dimensions corresponding to the dimensions of a slab.

It is also possible to replace the braising step by a steam cooking step.

Among the advantages of the invention, it is found that a slab of fish is obtained that is particularly smooth, even though the method includes a sterilization step which tends to dry out the slab.

1. A method of conserving foodstuffs, the foodstuffs comprising fish and being in the form of a slab, wherein the method comprises the following preparation steps:
preparing raw fish by adding a water-retaining agent;
forming a slab; and
sterilizing the foodstuffs.

2. A method according to claim 1, wherein the water-retaining agent comprises carrageenans.

3. A method according to claim 1, wherein the water-retaining agent is added by churning.

4. A method according to claim 1, including a step of adding an enzyme, such as transglutaminase.

5. A method according to claim 1, wherein the slab-forming step comprises a step of molding a block of fish, and a subsequent step of portioning the block into a plurality of slabs.

6. A method according to claim 5, wherein the forming step includes a maturing step during which the molded block of fish is stored for a duration of longer than 12 h at a temperature of less than 6° C. prior to being subjected to portioning.

7. A method according to claim 6, including a crusting step following the step of maturing the block of fish, during which crusting step said block of fish is exposed to a temperature lying in the range −25° C. to −15° C. for a duration longer than 20 min.

8. A method according to claim 1, wherein the slab is substantially rectangular in shape and is of weight lying in the range 70 g to 250 g.

9. A method according to claim 1, including a grilling step prior to sterilization.

10. A method according to claim 1, during which the slab-forming step is a step of assembling together whole fish pieces.

11. A method according to claim 1, wherein the fish is tuna.

12. A method according to claim 1, including a step of packaging and vacuum-sealing or of inert gas injection.

13. Foodstuffs packaging for long-duration conservation of the foodstuffs, the foodstuffs comprising fish and being in the form of a slab, wherein the slab comprises one to five whole fish pieces.
